(19) United States
(12) Patent Application Publication
(10) Pub. No.: US 2013/0210679 A1
(43) Pub. Date: Aug. 15, 2013

(54) METAL NANOPARTICLE ORGANIC COMPOSITE FILM AND METHOD FOR ITS PREPARATION

(71) Applicants: Yvonne JOSEPH, Fellbach (DE); Isabelle Raible, Tuebingen (DE); Nadejda Krasteva, Fellbach-Schmiden (DE); Gabriele Nelles, Stuttgart (DE)

(72) Inventors: Yvonne JOSEPH, Fellbach (DE); Isabelle Raible, Tuebingen (DE); Nadejda Krasteva, Fellbach-Schmiden (DE); Gabriele Nelles, Stuttgart (DE)

(73) Assignee: Sony Corporation, Tokyo (JP)

(21) Appl. No.: 13/587,256

(22) Filed: Aug. 16, 2012

(30) Foreign Application Priority Data
Sep. 9, 2011 (EP) 11007362.4

(51) Int. Cl. H01C 17/00; G01N 27/12

(52) U.S. Cl. CPC H01C 17/00; G01N 27/127
USPC 506/21; 427/103; 427/560; 427/102; 556/9

(57) ABSTRACT

The present invention relates to method for preparing a metal nanoparticle organic composite film, preferably a metal nanoparticle organic composite film of a chemical sensing device, to a metal nanoparticle organic composite film obtained by said method, and to a chemical sensing device comprising a metal nanoparticle organic composite film or an array of different metal nanoparticle organic composite films obtained by said method.

The present invention relates to method for preparing a metal nanoparticle organic composite film, preferably a metal nanoparticle organic composite film of a chemical sensing device, to a metal nanoparticle organic composite film obtained by said method, and to a chemical sensing device comprising a metal nanoparticle organic composite film or an array of different metal nanoparticle organic composite films obtained by said method.

Composites from metal nanoparticles and organic molecules can be used as sensitive layers in chemical sensors [1]. Two different kinds of metal nanoparticle/organic composites exist. First, metal nanoparticles encapsulated with organic ligands (type “A”) and, second, metal nanoparticles which are connected (interlinked) by organic molecules (type “B”). While in both types of composite material the nanoparticles in the film are most important for the conductivity of the material, the kind and amount of organic molecules determine the volatile organic compound (VOC) sorption properties of the materials [1,2]. Thus, a broad variety of materials with tuneable selectivity can be achieved by choosing appropriate organic ligand or linker molecules [3].

Due to the conductivity of the material, the coating is especially suited for chemiresistor devices. Here, the sensing of VOCs is based on two effects:
swelling of the material due to penetration of the analyte into the nonconductive organic matrix, wherein the swelling-induced change of the distance between the conducting nanoparticles provokes an increase in the resistance, which is then measured as sensor signal; and
pore filling of the material due to penetration of the analyte into empty pores of the composite, wherein the pore filling-induced change of the permittivity of the organic matrix provokes a decrease in the resistance, which is then measured as sensor signal.

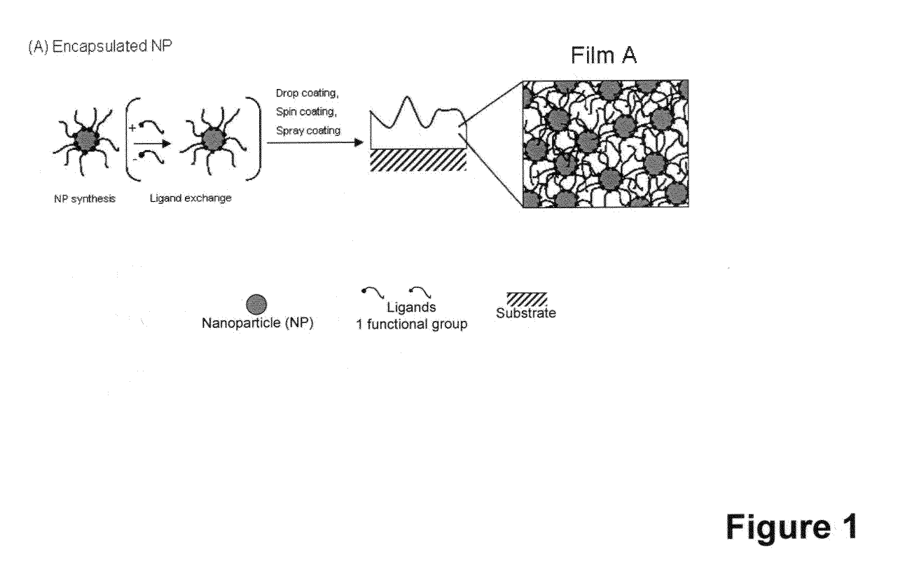

Films comprising metal nanoparticles encapsulated with organic ligands (i.e. organic materials with only one functional group, which is bound to the surface) can be prepared by drop coating, spin coating, spray coating or dip coating as shown in FIG. 1. The resulting films (type “A”) are often thick, rough, have an undefined structure, and the particles within the film are not chemically interlinked. Furthermore, there is no control of the presence, size and kind of pores. Also, the composition of the material varies only with variation of the organic ligands e.g. as a result of the nanoparticle synthesis or by ligand exchange. Finally, the deposition process does not provide high reproducibility.

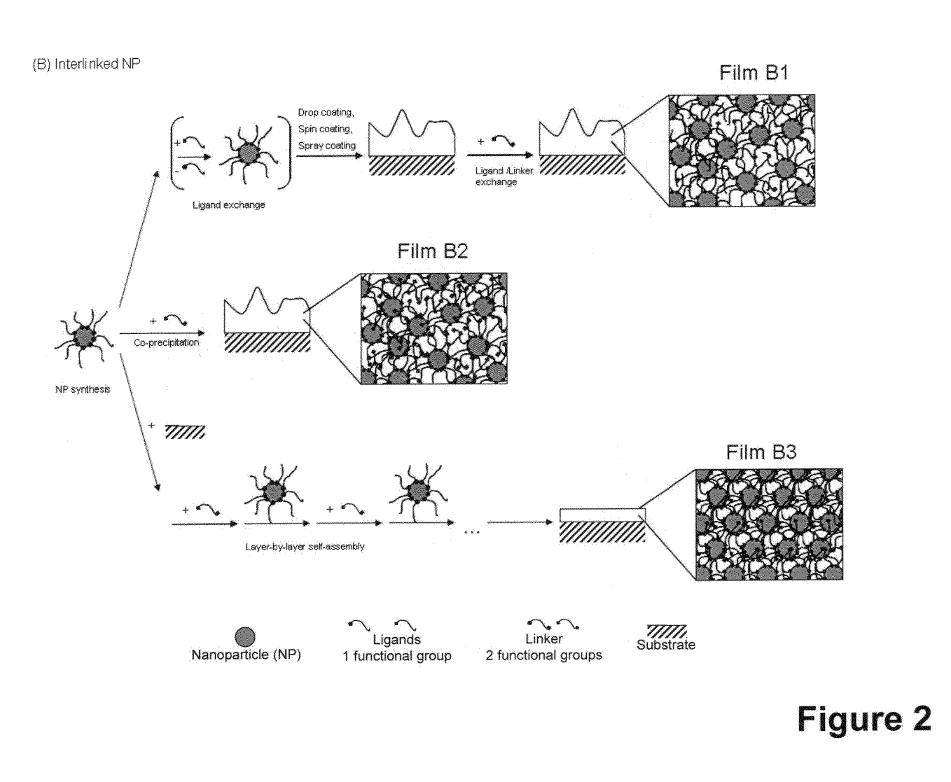

As shown in FIG. 2, type “B” films of metal nanoparticles interlinked with organic molecules (comprising two or more functional groups, that are able to bind to the nanoparticles) can be prepared by three different processes:
ligand/linker exchange, resulting in film “B1”;
co-precipitation, resulting in film “B2”; and
layer-by-layer self-assembly, resulting in film “B3”.

Films prepared by ligand/linker exchange (“B1”) have the same properties as the film “A”, except that the mechanical stability is slightly enhanced due to the chemical interlinkage and that, in the film, unbound headgroups of the linker molecules may be present. However the process is not well controlled, and diffusion of the linker into and of the ligand out of the bulk of the composite is a problem. Additionally, these processes are known to often be very slow, especially when the organic linker and ligands have the same functional groups.

Ligand-linker exchange by co-precipitation is performed by mixing solutions of nanoparticles and linker molecules and waiting for the deposition of the composite on the substrate by precipitation. It is the worst method in terms of gaining control over the film structure. It generates the roughest, most disordered and often very thick films (“B2”). In addition, the ratio of ligand to bound and unbound linker is hard to control, which leads to the presence of unbound headgroups in the materials. The size and structure of their pores as well as the degree of interlinkage are undefined, as well.

Nanoparticle films interlinked with organic molecules can be additionally prepared by layer-by-layer (1-b-1) self-assembly on the sensor transducer [1,2]. Here, the substrates are alternately immersed into nanoparticle solutions and solutions of organic molecules, resulting in an assembly of the material by chemical reaction (ligand/linker exchange). An advantage of this preparation method (compared to the others) is the precise film architecture and composition that is controlled by the chemistry of the used nanoparticles, the organic molecules and the involved ligand/linker exchange reaction. The structure of film “B3” is the most homogenous one concerning composition and thickness. The ligands are exchanged with linkers in the very controlled layer-by-layer procedure. However, the pore structure is also not tuneable, and the degree of interlinkage and composition is solely determined by the chemistry between nanoparticles and organics.

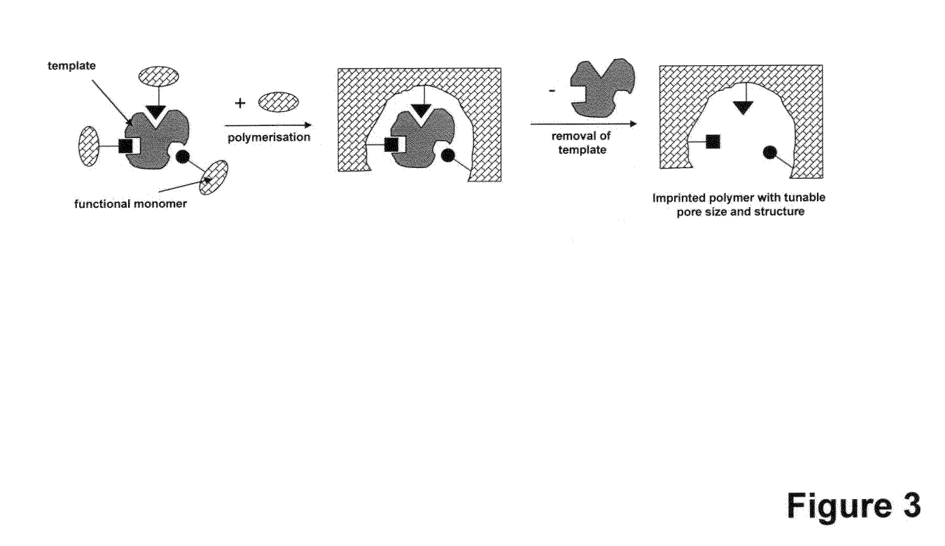

Often, templates are used in order to tune the pore size and structure of materials. To synthesize porous inorganic solids, template-assisted sol-gel procedures are employed. For organic polymers, the molecular imprinting technology is applied (see e.g. [4]). For molecular imprinting of polymers, the polymerisation reaction of the functional monomers takes place in the presence of a template (additive), which is not reactive in the polymerization process. After removal of the template, the polymer is “imprinted”. The resulting pore can then be used to sorb molecules that are similar (in size and structure) to the template. A scheme of the process is shown in FIG. 3. Molecular imprinting of nanoparticle composites are only known for deposition by electropolymerisation [5].

One of the most interesting features of materials preparation is the locally confined deposition of the material on relevant regions on a surface. Drop coating of materials allows this intrinsically. For other deposition techniques (spin- spray- or dip-coating and evaporation) patterning of the material by lithographic methods is necessary. For organic materials or organic/inorganic composites conventional lithographic techniques cannot be used due to the solubility of the material in organic solvents, which are needed for the lithographic process. In this case, the use of a water-soluble mask can be used for patterning the surface [6].

For advanced sensing applications in trace detection of gaseous species, e.g. in the fields of medical diagnosis, food quality and environmental control, there is a large need for highly sensitive and reproducible sensors for volatile organic compounds (VOCs). Metal nanoparticle organic composites are well suited as sensitive layers on chemiresistors.

An optimized chemisensitive nanocomposite layer for VOC detection should have the following

a) structural properties:
thin (between 20 and 200 nm), allowing fast responses by avoiding diffusion limiting effects;
highly porous, providing high sorption capacity for the VOCs;
variable pore size, providing size selectivity for different VOCs;
variable interlinkage, allowing either mechanical and chemical stability or high swelling capability or both to a certain extinct;
reproducible structure, allowing reproducible sensor performance;

b) chemical properties:
selectable organics, allowing tuneable selectivity;
selectable composition of the material (ratio between the organic component and the particles), allowing tuneable selectivity and sensitivity;
no extended conductive structures in the organic component, allowing for an optimal working sensing mechanism;

c) substrate interface properties:
substrate independent, providing the possibility of using roll-to-roll processes;

d) patterning properties:
the materials should be deposited only at the desired location, thereby allowing easy integration in the sensor device;
the deposition area should be small (miniaturization).

In terms of these requirements, the films grown by layer-by-layer self-assembly are the most suitable up to now. They are thin and have a reproducible structure and composition. The organics can be selected according to the desired sorption properties. However, it would also be desirable to tune the pore size and structure in a process that is similar to molecular imprinting and to tune the degree of interlinkage and the composition of the film, as swelling and pore filling are known to be important for the transduction of the sorption of VOCs into a measurable sensor signal. Additionally, it would be desirable to avoid dipping the substrates into solutions, to allow the use of plastic substrates and to avoid lithographic techniques for patterning. The current methods of preparation of such material do not offer these possibilities.

Thus, there is a need for a preparation method which allows the tuning of the (pore) structure, the degree of interlinking and the composition, while avoiding the dipping into solutions and maintaining the good properties of layer-by-layer self-assembled films with respect to film quality and reproducibility of formation. This preparation method should further allow to pattern the material on the surface in a desired manner in order to save material (and thus costs) and to avoid contaminations of other parts of the device with a semi-conductive layer.

The above objects of the present invention are solved by a method for preparing a metal nanoparticle organic composite film, preferably a metal nanoparticle organic composite film of a chemical sensing device, said method comprising the steps:
a) providing a substrate;
b) depositing a solution of ligand stabilized metal nanoparticles onto a surface of said substrate by drop coating, spray coating or spin coating, preferably by drop coating or spray coating;
c) drying the result of step b);
d) depositing a solution of an organic linker molecule onto said surface by drop coating, spray coating or spin coating, preferably by drop coating or spray coating;
e) drying the result of step d);
   optionally f) washing the result of step e);
g) repeating steps b) to e), optionally steps b) to f), thereby forming said metal nanoparticle organic composite film on said surface of said substrate, wherein said steps b) to e), optionally steps b) to f), are repeated until said film has a desired thickness;
h) evaporating, washing or evacuating the result of step g);
i) drying the result of step h); and
   optionally j) post-treating the result of step i), e.g. by controlled oxidation or coating with a sensitivity enhancing layer.

In one embodiment, said depositing b) and d) is performed by drop coating.

In one embodiment, said substrate comprises a material selected from glass, quartz, ceramics, polyethylene, polycarbonate, flexible polymer materials, silicon, ITO, FTO, metal oxides and carbon.

In one embodiment, said substrate is a transducer.

In one embodiment, said substrate is not a transducer, but has another function, e.g. in a tubing or display.

In one embodiment, said substrate is a flexible substrate.

In one embodiment, said flexible substrate comprises or is made of a polymer.

In one embodiment, said flexible substrate comprises or is a gel.

In one embodiment, said flexible substrate is a biological substrate, e.g. skin or tissue.

In one embodiment, said flexible substrate is a piece of fabric.

In one embodiment, said substrate is patterned. For example, said substrate may expose wells.

In one embodiment, prior to performing steps b) to j) (wherein steps f) and j) are optional), said surface of said substrate is at least partially functionalized to modify (i.e. to increase or to decrease) the wettability of said surface and/or the adhesion of said film to said surface, and/or is at least partially coated with a protecting layer, which, preferably, is inert to the used solvent, such as a layer made of SiO₂ or other oxides.

Preferably, said solutions of said ligand stabilized metal nanoparticles and said organic linker molecule are dilute solutions. The term “dilute” solution is meant to refer to any solution that allows the production of a monolayer or submonolayer of the solute(s).

In one embodiment, the concentration of said ligand stabilized metal nanoparticles in said solution is selected so as to ensure that a given area of said surface is covered with a monolayer or submonolayer of nanoparticles. Preferably, 10 to 100% of said surface are covered with a monolayer, more preferably 50 to 100% of said surface are covered with a monolayer, most preferably 80 to 100% of said surface are covered with a monolayer.

In one embodiment, in step d), said organic linker molecule is deposited in an amount of from 1 to 500 pmol/mm², preferably of from 20 to 100 pmol/mm².

In one embodiment, in step b), said ligand stabilized nanoparticles are deposited such that a monolayer or submonolayer of particles is formed.

The phrase “said ligand stabilized nanoparticles are deposited such that a monolayer or submonolayer of particles is formed”, as used herein, is meant to refer to a way of applying the nanoparticles in a manner so as to result in a monolayer or submonolayer of particles. It should be noted that, in one embodiment, once the monolayer or submonolayer of particles is formed, no further deposition of nanoparticles occurs. It should be noted that in one embodiment, it is only of minor importance what the ultimate concentration of the deposition solution in terms of nanoparticle concentration is. Rather in this embodiment, it is more important how much material of nanoparticle from the solution is finally deposited on the substrate, after evaporation of the solvent. There are various factors that affect the amount of finally deposited material, such as applied volume which defines the total amount of materials besides the solvent, the concentration of the solution, the spreading of the solution which defines the area on which the solution is coated, and the material itself. If one assumes that a given total amount of material from a linker solution is deposited, the area of the substrate on which the defined volume with a defined concentration is applied is important. Consequently, in one embodiment, the linker concentration is with respect to the coated area (pmol/mm²). With respect to the nanoparticle deposition, the material itself is of relevance, in that the size, the size distribution and the geometry of the particles may vary. For this reason, a molar concentration, i.e. a number of particles in the solution, can not be generally defined, without unduly limiting the scope. Consequently, instead, in one embodiment, step b) is defined in terms of substrate coverage by a monolayer or submonolayer. A person skilled in the art knows how to deposit a solution of nanoparticles so as to achieve a monolayer or submonolayer coverage.

In one embodiment, said solution of an organic linker molecule further comprises an additive having a size similar to a desired pore size, which additive is removed during step h), optionally during steps f) and h). Preferred additives include aromatic and aliphatic hydrocarbons, hydrocarbons containing heteroatoms or water-soluble nanoparticles.

In one embodiment, said drying c), e) and/or i) is performed under an atmosphere selected from an ambient, inert, oxidising and reducing atmosphere. In one embodiment, the entire process is performed under an atmosphere selected from an ambient, inert, oxidising and reducing atmosphere.

In one embodiment, said drying c), e) and/or i) is performed under a humidity controlled atmosphere. In one embodiment, the entire process is performed under a humidity controlled atmosphere.

In one embodiment, said drying c), e) and i) is performed by means of a stream of gas, preferably of an inert gas. In one embodiment, said drying is performed by means of a stream of nitrogen.

In one embodiment, in step g), steps b) to e), optionally steps b) to f), are repeated at least 5 times, preferably at least 10 times, more preferably at least 15 times.

In one embodiment, said film has a thickness in the range of 10 nm to 500 nm, preferably 15 to 300 nm, more preferably 20 to 200 nm.

The solvent or solution used for the washing steps will depend on the kind of substrate, nanoparticles and linker molecules used in the method. Preferably, the same solvent as used for said solution of the organic linker molecule is used. Particularly preferred solvents include organic solvents, such as aromatic hydrocarbons (e.g. toluene), aliphatic hydrocarbons (e.g. hexane) or hydrocarbons containing heteroatoms (e.g. acetone, methanol, propanol, ethanol) and water.

In one embodiment, said washing h) further comprises ultrasonic treatment.

In one embodiment, in steps b) and d), said solution is deposited only onto a confined area of said surface or in a defined pattern.

The objects of the present invention are also solved by a metal nanoparticle organic composite film obtained by the method as defined above.

In one embodiment, said film has a homogenous composition, a homogenous pore size and structure, and/or a homogenous, preferably low, degree of interlinkage between said metal nanoparticles. The degree of interlinkage is represented by the ratio of the functional groups bound to the nanoparticles relative to the total number of functional groups. A ratio between 5% to 80% is preferred, a ratio of 10% to 60% is more preferred, a ratio of 20% to 50% is most preferred.

The objects of the present invention are also solved by an array of different metal nanoparticle organic composite films as defined above, wherein, preferably said different metal nanoparticle organic composite films are formed on a single substrate.

The objects of the present invention are further solved by a chemical sensing device comprising a metal nanoparticle organic composite film as defined above or an array of different metal nanoparticle organic composite films as defined above.

The term “nanoparticle”, as used herein, is not limited to spherical nanoparticles, but is meant to refer to structures (including rods or fibers) where at least one dimension of the structure is in the order of nanometers, i.e. <1 μm, preferably ≦500 nm, more preferably ≦300 nm, most preferably ≦100 nm.

Preferably, the metal nanoparticles comprise a metal selected from gold, silver, platinum, palladium, copper and alloys thereof. In one embodiment, said metal nanoparticles are core-shell nanoparticles, being electrically conductive and having a shell from a metal selected from gold, silver, platinum, palladium, copper and alloys thereof.

The term “ligand stabilized metal nanoparticles”, as used herein, is meant to refer to metal nanoparticles surrounded/encapsulated by organic or metal-organic ligands having a single functional group, which single functional group binds to said metal nanoparticles.

The term “metal nanoparticle organic composite”, as used herein, is meant to refer to a composite consisting of metal nanoparticles and organic molecules, in particular organic linker molecules interlinking said metal nanoparticles.

The term “organic linker molecule”, as used herein, is meant to refer to flexible or rigid and linear or branched organic or metal-organic molecules comprising at least two functional groups that bind to said metal nanoparticles (“bi-functional” or “poly-functional” linkers).

The length of the organic linker is important for the sensitivity. A length of 5 to 30 methylene units (or equivalents) is preferred, a length of 10 to 30 methylene units (or equivalents) is more preferred, a length of 20 to 30 methylene units (or equivalents) is most preferred.

A functional group may be selected from a hydroxyl group, amino group, carboxyl group, carboxylic acid anhydride group, dithiol carboxylic acid group, mercapto/thiol group, disulfide group, thioether group, thioctic acid group, trithiocarbamate group, dithiocarbamate group, xanthate group, isothiocyanate group, isocyanide groups, tin, selen or mercury group.

Preferred organic ligands include molecules which contain a functional group that can be easily exchanged against another functional group when bound to a nanoparticle surface; for example, amines bound to gold nanoparticles can be exchanged with thiols.

Preferred organic linker molecules include C₅-C₃₀-alkane dithiols, such as nonanedithiol, decanedithiol, undecanedithiol, dodecanedithiol, etc. Other exemplary linkers, which can be used in accordance with the present invention, are disclosed in references [1] to [3].

The inventors have surprisingly found that the method of layer-by-layer drop/spin/spray coating as described herein offers the possibility to tune the relevant film parameters of composition, pore structure and degree of interlinkage, and thus allows to prepare a sensing material with the proposed optimal structure. In addition, the suggested drop-supported layer-by-layer self-assembly allows molecular imprinting of the composites as well as patterning of the material.

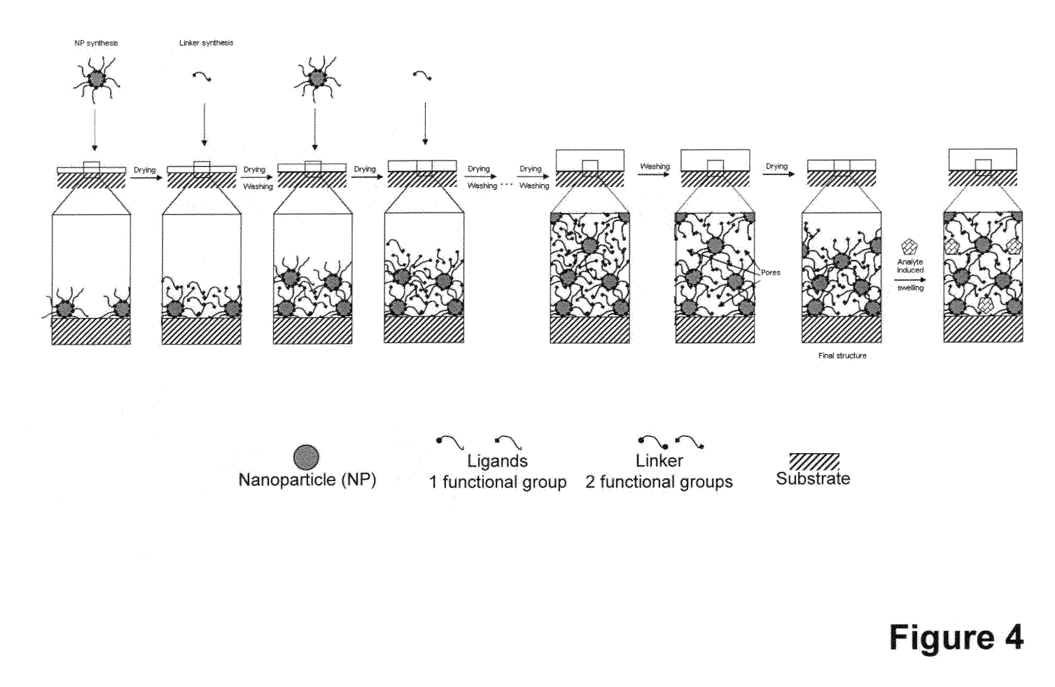

In the process according to the present invention, nanoparticles and organic linker molecules are alternately deposited by drop coating, spray coating, or spin coating on a substrate, preferably a transducer (see FIG. 4). After each of these steps, the sample should dry to ensure complete deposition of the material on the surface. In between the deposition steps, the sample may be washed. This refers to a preparation cycle in the following description. During each preparation cycle, the available nanoparticles were ligand exchanged with the available linker molecules. The optional consecutive washing would remove all excess materials, which are not (at least weakly) chemically or physically bound to the film material. Thus, the composition of the film material depends on the concentrations in the nanoparticle and linker solutions used for deposition as well as on the interaction between both compounds. In contrast, in the conventional layer-by-layer dip coating process, only the chemistry between both compounds determines the composition, and no excess material of nanoparticle or linker can be deposited.

The number of applied consecutive deposition cycles will determine the thickness of the film and is, thus, a method to tune the resistance of the chemiresistor sensor for a given interdigitated electrode structure. To finalize the process, after the selected number of deposition cycles a final wash (possibly with ultrasonic treatment) is suitable, to remove unbound organic molecules and to generate pores, which will possibly collapse when the film is drying. This collapsed structure may then swell, when VOCs are present in the environment.

To tune the pore size and structure, the molecules in the linker solution are important. The solvent as well as un- or weakly bound linker or exchanged ligand molecules may be entrapped during the preparation process and may be removed in the final washing step leaving voids in the material. To expand this concept, selected additional molecules (additives) can be used together with the linker in the organic solution during deposition. This would allow the possibility to shape the pore size and structure in a way that is suitable to host the additive. Due to the layered nature of the deposition process, non-volatile additives can be easily incorporated during the drop, spin or spray coating process. If a removal afterwards is possible by the correct washing treatment, the size and structure of the pores can be tuned. In the easiest case, solvents with low volatility or surplus of linker or ligand molecules can be imprinted. By deposition and removal of a carefully selected additive (e.g. the desired analyte) the desired pore can be generated.

Due to the fact that in the layer-by-layer drop, spin, or spray coating an immersion of the substrate into the solvent can be omitted, plastic and or flexible substrates can be coated. In case of solubility/swellability of the substrate in contact with the solvent, thin protecting layers e.g. SiO₂ can be applied. This allows continuous or even roll-to-roll processes.

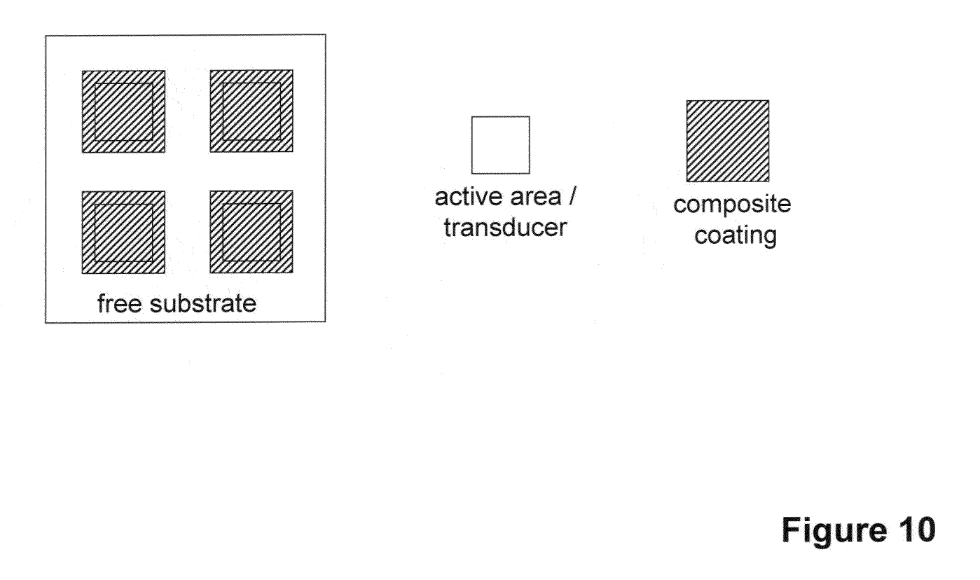

An advantage of the layer-by-layer drop coating/casting method compared to the proposed layer-by-layer spin or layer-by-layer spray coating is that only the required material necessary for film preparation is used for deposition in dilute solutions. This saves chemicals, and thus production costs, and is preferred due to environmental reasons. Also, the preparation of arrays is favoured by layer-by-layer drop coating/casting, as the deposition of different materials at different locations on the substrate, i.e. patterning, is possible (see Example 6 and structures shown in FIGS. 10 to 15). This allows to avoid lithographic methods. The minimum size of such a material pattern is defined by the droplet size and wetting properties of the substrate.

During the proposed layer-by-layer drop coating method, the following parameters allow to influence the formation of the film, and thus the final performance of the sensitive coating:
Preparation atmosphere
In contrast to the layer-by-layer self-assembly, the films are exposed to a certain atmosphere during the drying step in the proposed coating procedure. Thus, it has to be taken into consideration that the atmosphere may alter the material, e.g. by oxidation or reduction (see Example 2). A reducing or oxidizing atmosphere can be even used to control the oxidation state of a redox-active linker (e.g. viologens) on purpose.
Wetting properties of the transducer
As the transducer is not continuously immersed into coating baths, the wetting and de-wetting properties of the transducer with the used solution as well as with the film is critical. A suitable surface functionalization may be applied to allow wetting of a certain area of the transducer with the solutions as well as to enable good adhesion of the final film. This surface functionalization may also be patterned to confine the droplet in a specified area.
Applied liquid volume per coating area
To have control on the amount of material which will be deposited on the transducer an exact control of the applied volume per coating area is required. This means that the solution dosing systems have to be calibrated and have to work very reproducible.
Composition of the solutions
A main parameter of the coating solutions is the kind of organic linker and ligand stabilized nanoparticles used. The functional groups of ligands and linker have to be chosen in a way that they easily undergo the ligand-linker-exchange reaction. The structure of the organic linker (flexible or rigid, linear or branched, bi- or polyfunctional, etc.) is as important as the size and structure of the nanoparticles (face-centered cubic or hexagonally close-packed, faceted or spherical, etc.).
A further parameter is the concentration of the used organic linker and nanoparticle solution. The solutions are preferably dilute solutions in order to deposit only a (sub-) monolayer of material each step to ensure an effective layer-by-layer drop coating and to allow structural control, but should not be too dilute in order to limit the number of necessary deposition steps.
Also, organic molecules in the solution (that are different from the linker molecules) can be of importance. Solvent or other (binding or non-binding) molecules in the solution can be entrapped in the deposited material and possibly removed later on during washing steps to create empty pores. This can happen accidentally in the presence of solvents or impurities or on purpose, using templates similar to molecular imprinting processes.
Evaporation rate
The evaporation of the solvents is very important for the homogeneity of the prepared film. Too fast evaporation may lead to structural inhomogenities, while too slow evaporation limits the preparation speed. Thus, the kind of solvent, the substrate temperature as well as the composition of the preparation atmosphere is important to control.
Washing
A further possibility to tune the amount of deposited material is the washing. Washing is important to control the excess of material which is deposited as non-linked material is washed away. Important parameters of the washing steps are the washing duration, type of solvent, whether ultrasonic treatment is used, and when in the process washing is applied (e.g. between the cycles or after the complete deposition).
Evacuation
Yet another possibility to tune the amount of deposited material is evacuation. Evacuation is important because it may control the excess of material which is deposited as non-linked material, by applying a vacuum. Important parameters of the evacuation steps are the evacuation duration, final pressure, and when in the process the vacuum is applied (e.g. between the cycles or after the complete deposition).

In summary, the preparation method according to the present invention allows for:
good and reproducible film quality;
tuneable degree of interlinkage;
tuneable composition;
tuneable redox state;
the generation of imprinted pores with tuneable size and structure;
compatibility with plastic or flexible substrates; and
easy patterning properties.

The improved composite films for sensing obtained by this method exhibit
higher sensitivity;
tuneable selectivity;
tuneable resistance;

and allow for
sensor arrays on a monolithic chip without lithographic methods; and
variations in the local composition by using different linkers.

Reference is now made to the Figures, wherein

FIG. 1 shows a scheme of a prior art method for preparing thin type “A” composite films by spin, spray or drop casting of metal nanoparticles encapsulated with organic ligands;

FIG. 2 shows a scheme of three prior art methods for preparing thin type “B” composite films “B1-3” of metal nanoparticles interlinked with organic molecules (comprising two or more functional groups that are able to bind the nanoparticles) by ligand/linker exchange (top), co-precipitation (middle) or layer-by-layer self-assembly (bottom);

FIG. 3 shows a scheme of a method for molecular imprinting of polymers to generate pores with a desired size and structure;

FIG. 4 shows a scheme of the layer-by-layer drop/spray/spin coating preparation process according to the present invention;

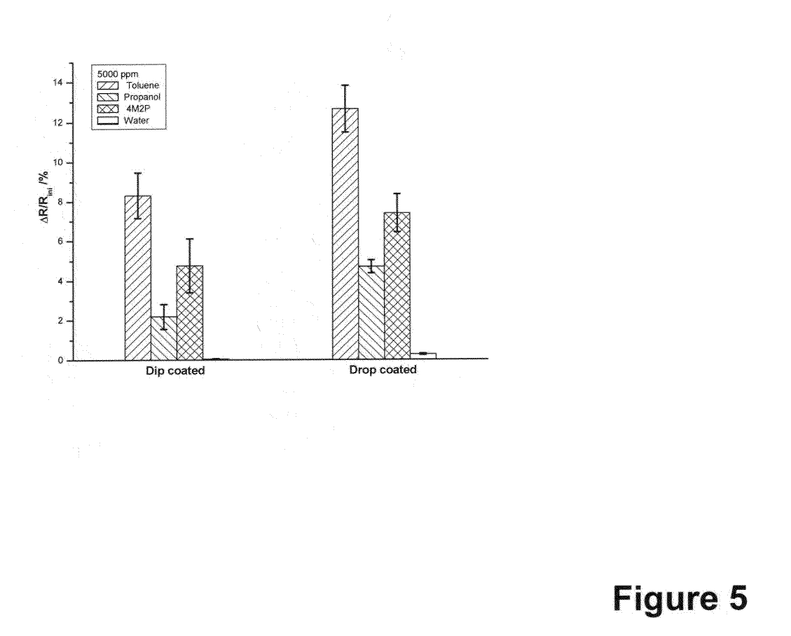

FIG. 5 shows a comparison of the sensitivities of AuDT films prepared with different methods towards 5000 ppm of the indicated analytes;

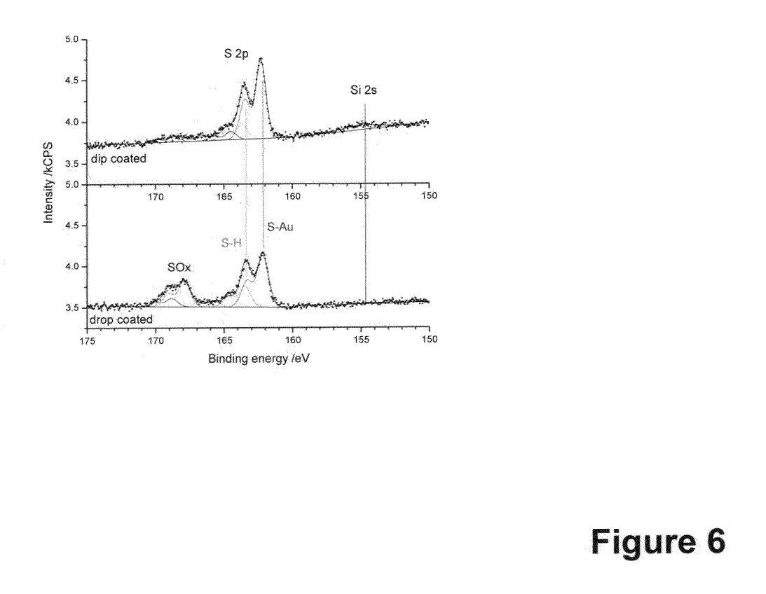

FIG. 6 shows S2p XP spectra indicating the degrees of interlinkage and oxidation of differently prepared materials;

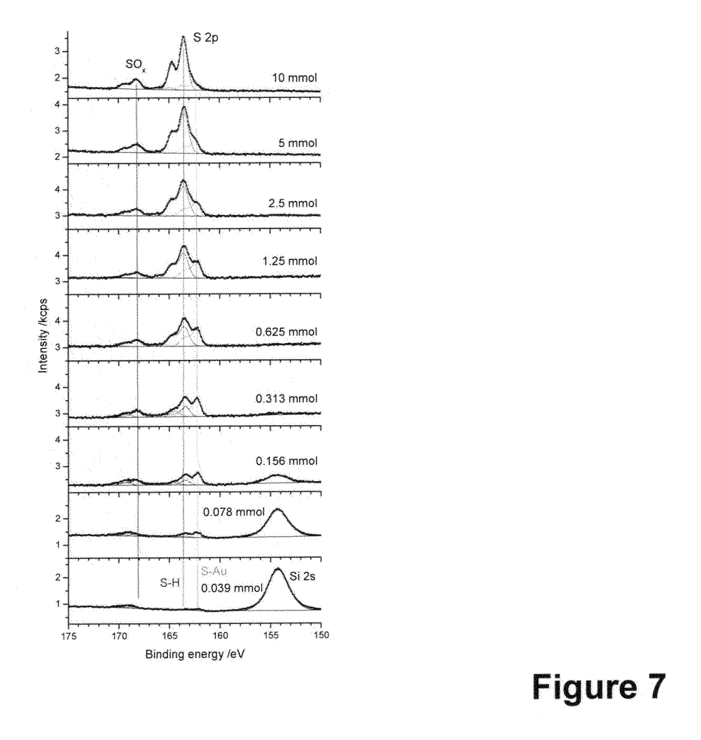

FIG. 7 shows S2p (and Si 2s) XP spectra of Au NT films as a function of varying linker concentrations in the linker solution;

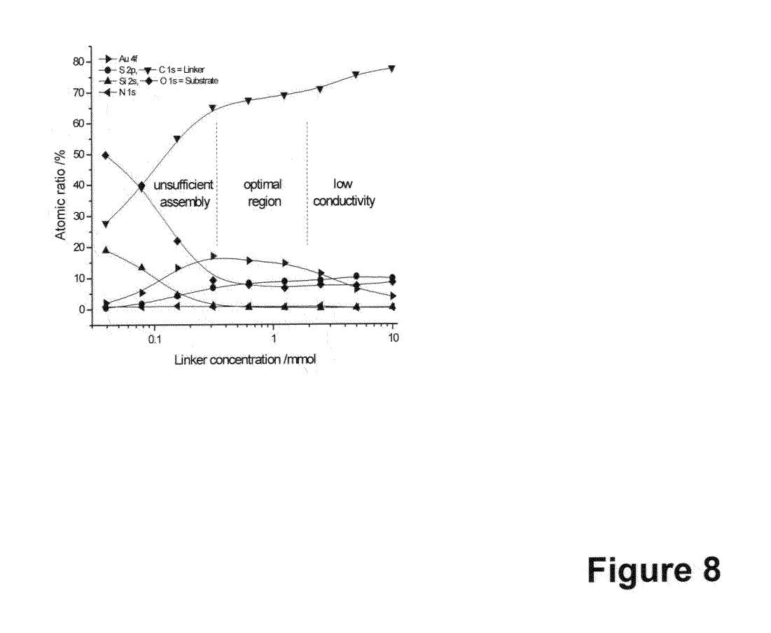

FIG. 8 shows the composition of the of layer-by-layer drop-coated AuNT film as a function of varying linker concentrations in the linker solution;

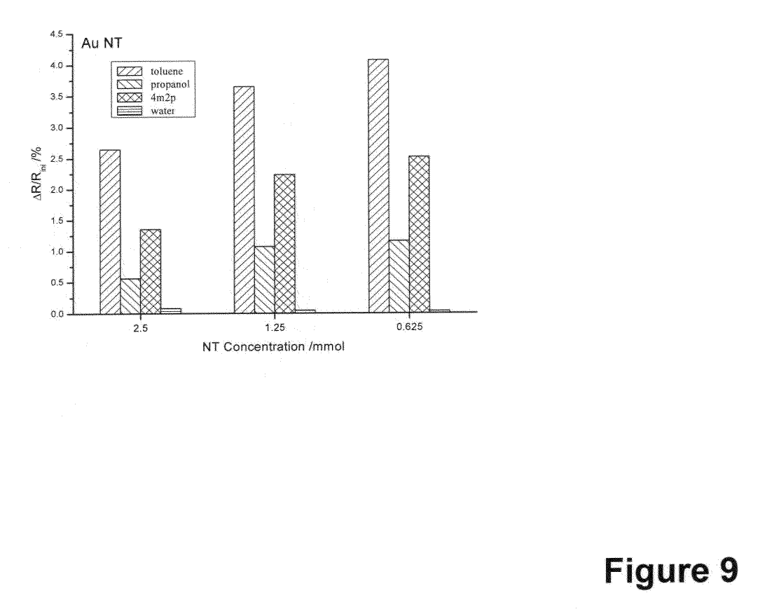

FIG. 9 shows a comparison of the sensitivities of AuNT films with different compositions and different degrees of interlinkage towards 5000 ppm of the indicated analytes; and

FIGS. 10, 11, 12, 13, 14 and 15 show various arrangements of a sensor composite on a substrate, which arrangements can be obtained by the layer-by-layer drop coating method according to the present invention.

The invention is now further described by means of the following examples, which are intended to illustrate the present invention and not to limit it.

### EXAMPLES

### Materials & Methods

All work has been performed under ambient conditions. If not otherwise stated, the linker concentration was 0.625 M in toluene. The Au nanoparticles were prepared according to a procedure from the literature [7] and their absorbance of the plasmon band was set to 1.0. Before coating, all samples were aminosilanized as described in the same literature as the nanoparticle synthesis and the layer-by-layer self-assembly procedure [7]. For the layer-by-layer drop coating, the commercially available device “NANOPLOTTER” (Gesim mbH, Groβerkmannsdorf, Germany) was used. For film formation, 40 nl/mm² of the respective solutions were spotted in accordance with the method shown in FIG. 4. After each linker spotting, the same amount of pure solvent was spotted over the films that should remove most of the excess material (“washing”). 20 deposition cycles were applied. At the end, the samples were washed for 1 minute in toluene while applying ultrasonic treatment and dried with a stream of nitrogen. The instruments for the XPS measurements and vapor sorption investigations are described in the literature [8].

### Results

### 1. Enhancement of Sensitivity of Films Prepared by Layer-by-Layer Drop Coating as Compared to Layer-by-Layer Dip Coated Films

For a comparison of the different assembly methods layer-by-layer drop coating (present invention) and layer-by-layer dip coating, sensor composites from gold nanoparticles and dodecanedithiol (DT) were prepared and their sensing properties towards toluene 1-propanol, 4-methyl-2-penanone and water were investigated. A comparison of the sensitivities is shown in FIG. 5.

The layer-by-layer drop-coated film showed for all analytes an at least 50% higher sensitivity than the conventional layer-by-layer dip coated material. This is due to the higher swelling ability thanks to a lower degree of interlinkage of the layer-by-layer drop coated film.

### 2. Influence of the Preparation Atmosphere

For a comparison of the different assembly methods, sensor composites from gold nanoparticles and dodecanedithiol (DT) were prepared under ambient conditions and their degrees of interlinkage and oxidation were investigated by X-ray photoelectron spectroscopy (XPS). The analysis is shown in FIG. 6.

The XP spectra shown in FIG. 6 indicate that the drop-coated sensors are less cross-linked (lower S—Au to S—H ratio) and higher oxidized (more SOx) than the drop coated material. The lower degree of interlinkage allows the drop coated film to swell more than the dip coated one, and thus allows a more effective transduction of the sorption process. The higher degree of oxidation is typical for sensors which are exposed to ambient air that contains ozone, while the films prepared by dip coating are covered all the time by a protecting liquid layer, and are thus prevented from the oxidizing atmosphere. The higher degree of oxidation of the drop coated film is expected to decrease the sensitivity towards hydrophobic analytes. A preparation under inert conditions, thus avoiding oxidation, will enhance the sensitivity of the drop coated sensors towards hydrophobic analytes.

### 3. Tuning of the Degree of Interlinkage

To show that the degree of interlinkage is variable during the layer-by-layer drop coating process, composites from gold nanoparticles (AuNP) and nonanedithiol (NT) were prepared. The concentration of NT in the linker solution relative to the nanoparticle concentration was varied over 3 orders of magnitude and the samples were studied by XPS. In FIG. 7, the S 2p (and Si 2s) spectra of the films are given to investigate the degree of interlinkage.

The substrate signal (Si 2s) is visible for films prepared with low linker concentration. All films are oxidized (SOx) due to ambient air as preparation atmosphere. The degree of interlinkage varies in the optimal preparation region, as seen by the ratio of S—H to S—Au (from 2:1 to 0.5:1). As expected, the lower the linker concentration, the higher the degree of interlinkage.

### 4. Tuning of the Film Composition

To show that the film composition is variable during the layer-by layer drop coating process, composites from gold nanoparticles (AuNP) and nonanedithiol (NT) were prepared. The concentration of NT in the linker solution relative to the nanoparticle concentration was varied over 3 orders of magnitude and the samples were studied with XPS. The variation in composition is shown in FIG. 8.

Three different composition regions can be identified:
A region of low concentrations of NT, where high substrate (Si and O; in blue) and low film signals (C, S and Au; black and orange) are observed, indicating insufficient film assembly. This indicates that the films are discontinuous, show low conductivity, and no structural control is possible.
A region of high linker concentrations, the linker signals are high and the gold signal is low, indicating a high fraction of organic material in the film, as expected. This also results in low conductivity of the materials.
An intermediate region, representing films that are thick and metal-rich enough to be conductive. These can be used as chemiresistors.

### 5. Influence of Composition and Degree of Interlinkage on the Sensitivity of the Materials

As the degree of interlinkage and composition is expected to influence the sensitivity of the material, composites from gold nanoparticles (AuNP) and nonanedithiol (NT) in the optimal region were prepared and their sensitivities towards 5000 ppm toluene, 1-propanol, 4-methyl-2-pentanone and water were investigated. The results are shown in FIG. 9.

It was observed that the response increases with decreasing concentration of linker and decreasing degree of interlinkage. The reason is presumably that excess of linker are not bound chemically but are entrapped in the network. Thus swelling is less possible, as the entrapped unbound linker is not removed completely during the washing.

In summary, the optimal structure is not too interlinked to limit effective swelling (like in the layer-by-layer grown films) and the unbound excess material has to be washed out effectively to enhance sorption of the desired analyte. The degree of interlinkage is represented by the ratio of the functional groups bound to the nanoparticles relative to the total number of functional groups. A ratio between 5% to 80% is preferred, a ratio of 10% to 60% is more preferred, a ratio of 20% to 50% is most preferred.

### 6. Patterning of Materials

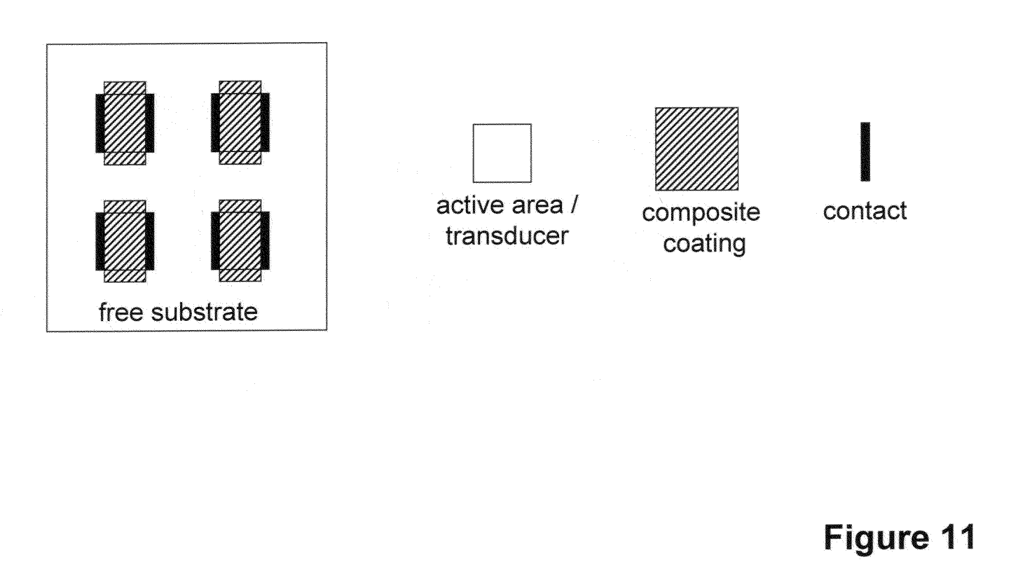

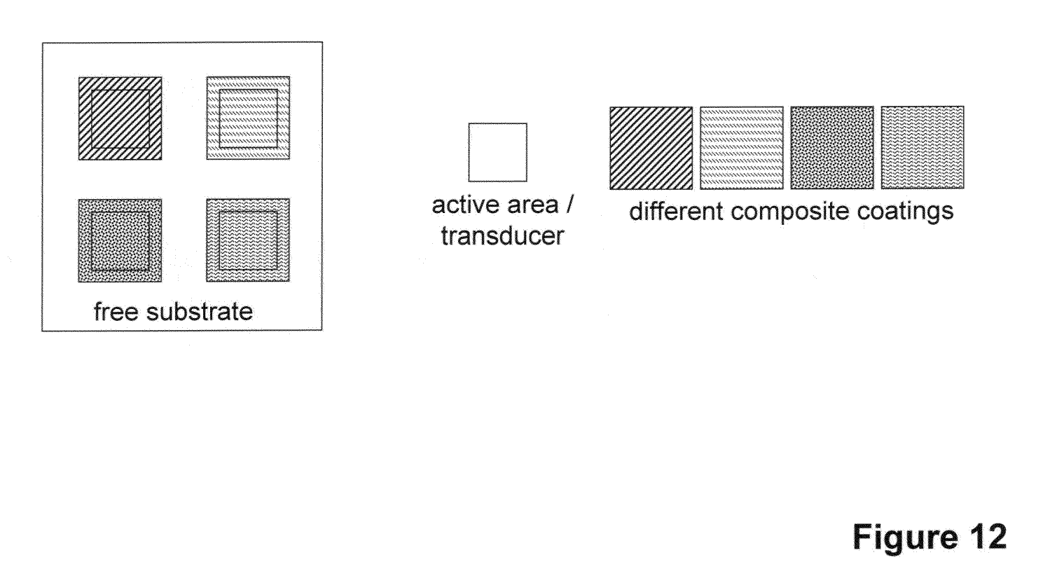

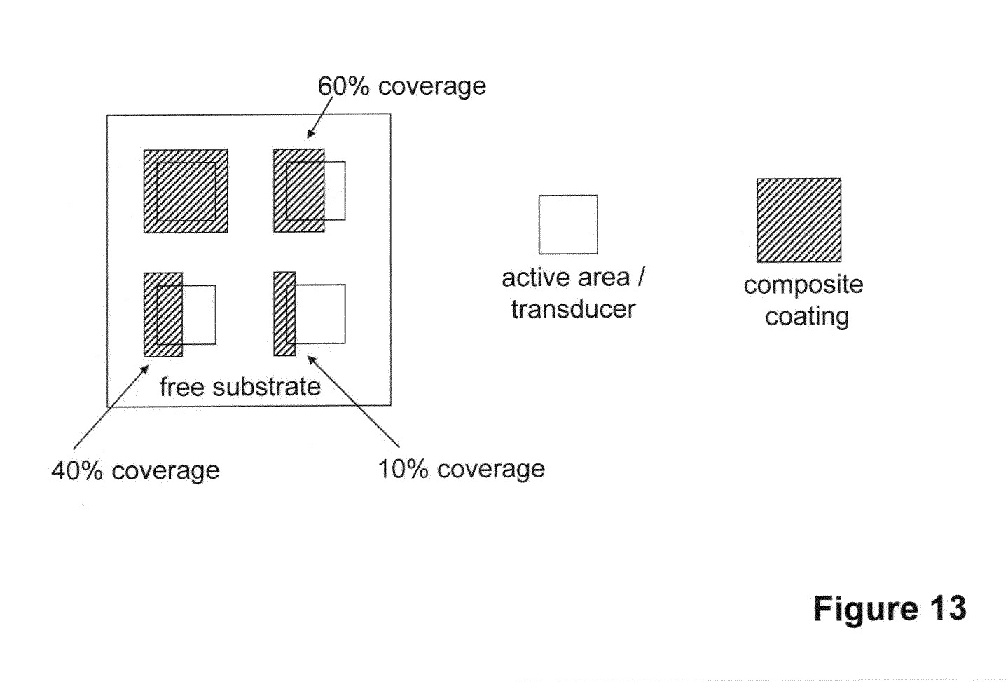

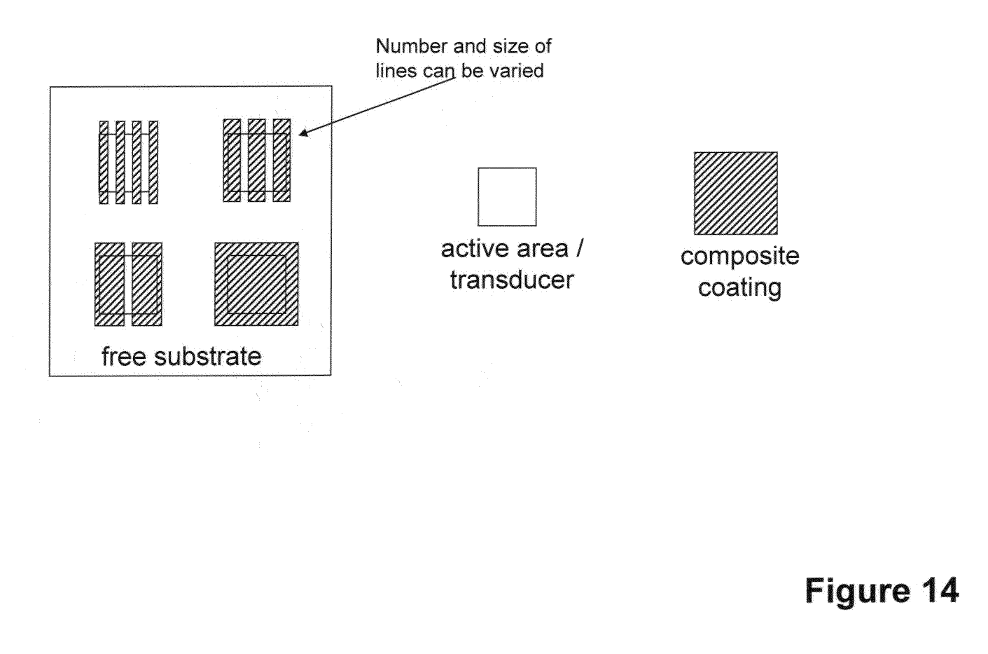

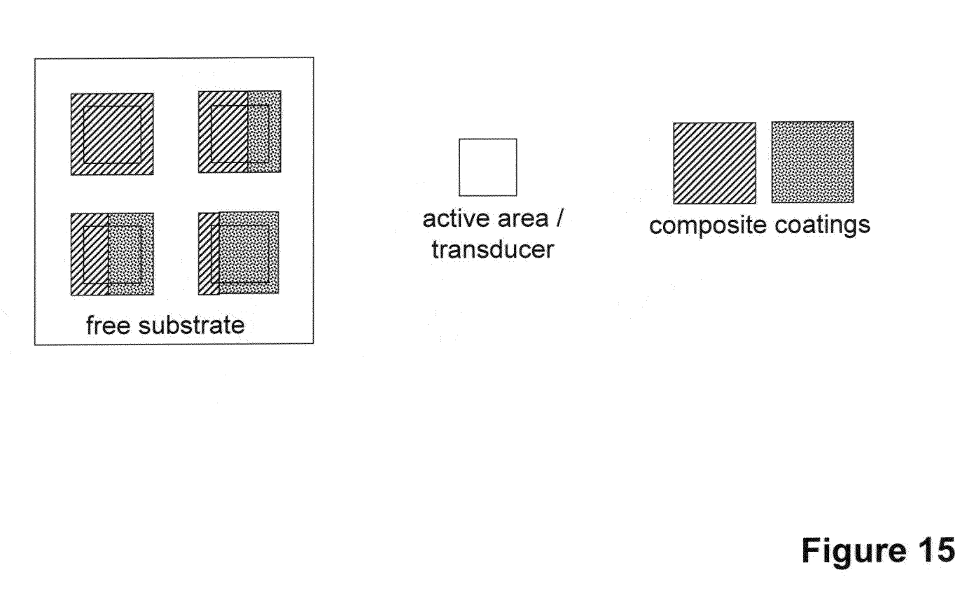

Drop coating allows the deposition of the material on selected areas on a device. The same works for the proposed layer-by-layer drop-coating approach. Beside the savings of cost and time, this may additionally result in
substrates, which are in part material-free, allowing isolation between active parts, thereby avoiding leak currents or uncoated electronic parts of the chip, e.g. ASIC chips (see FIG. 10);
material-free contacts, thereby avoiding contact resistances and other contact problems (see FIG. 11);
monolithic materials arrays (different materials or film thicknesses on a single substrate), thereby avoiding multiple production procedures (see FIG. 12);
partial coating of the active transducer area of a chemiresistor (inter-digital electrode), allowing the tuning of the resistance of the device (see FIG. 13);
coating of the active transducer area of a chemiresistor (inter-digital electrode) with lines. By choosing the number and size of the lines the base resistance can be tuned (see FIG. 14);
coating of the active transducer area of a chemiresistor (inter-digital electrode) with only two different materials (see FIG. 15).

### REFERENCES

[1] EP 1022560 A1.
[2] U.S. Pat. No. 7,939,136
[3] EP 1215485 A1.
[4] U.S. Pat. No. 6,582,971.
[5] Riskin et. al, Journal of the American Chemical Society, 131, (2009), 7368-7378.
[6] EP 1510861 A1.
[7] Joseph et al., J. Phys. Chem. B 2003, 107, 7406-7413.
[8] Joseph et al., Chem. Mater. 2009, 21, 1670-1676.

1. A method for preparing a metal nanoparticle organic composite film, preferably a metal nanoparticle organic composite film of a chemical sensing device, said method comprising the steps:
a) providing a substrate;
b) depositing a solution of ligand stabilized metal nanoparticles onto a surface of said substrate by drop coating, spray coating or spin coating, preferably by drop coating or spray coating;
c) drying the result of step b);
d) depositing a solution of an organic linker molecule onto said surface by drop coating, spray coating or spin coating, preferably by drop coating or spray coating;
e) drying the result of step d);
optionally f) washing the result of step e);
g) repeating steps b) to e), optionally steps b) to f), thereby forming said metal nanoparticle organic composite film on said surface of said substrate, wherein said steps b) to e), optionally steps b) to f), are repeated until said film has a desired thickness;
h) evaporating, washing or evacuating the result of step g);
i) drying the result of step h); and
optionally j) post-treating the result of step i).

2. The method according to claim 1, wherein said depositing b) and d) is performed by drop coating.

3. The method according to claim 1 or 2, wherein said substrate is a transducer.

4. The method according to claim 1, wherein said substrate is a flexible substrate.

5. The method according to claim 1, wherein said substrate is patterned.

6. The method according to claim 1, wherein prior to performing steps b) to j), said surface of said substrate is at least partially functionalized to modify the wettability of said surface and/or the adhesion of said film to said surface, and/or is at least partially coated with a protecting layer.

7. The method according to claim 1, wherein, in step d), said organic linker molecule is deposited in an amount of from 1 to 500 pmol/mm², preferably of from 20 to 100 pmol/mm².

8. The method according to claim 1, wherein, in step b), said ligand stabilized nanoparticles are deposited such that a monolayer or submonolayer of particles is formed.

9. The method according to claim 1, wherein said solution of an organic linker molecule further comprises an additive having a size similar to a desired pore size, which additive is removed during step h), optionally during steps f) and h).

10. The method according to claim 1, wherein said drying c), e) and/or i) is performed under an atmosphere selected from an ambient, inert, oxidising and reducing atmosphere, wherein, preferably, said atmosphere is a humidity controlled atmosphere.

11. The method according to claim 1, wherein in step g), steps b) to e), optionally steps b) to f), are repeated at least 5 times, preferably at least 10 times, more preferably at least 15 times.

12. The method according to claim 1, wherein said film has a thickness in the range of 10 nm to 500 nm, preferably 15 to 300 nm, more preferably 20 to 200 nm.

13. The method according to claim 1, wherein said washing h) further comprises ultrasonic treatment.

14. The method according to claim 2, wherein, in steps b) and d), said solution is deposited only onto a confined area of said surface or in a defined pattern.

15. A metal nanoparticle organic composite film obtained by the method according to claim 1.

16. A chemical sensing device comprising a metal nanoparticle organic composite film according to claim 15 or an array of different metal nanoparticle organic composite films according to claim 15.
